(19) United States
(12) Patent Application Publication
(10) Pub. No.: US 2024/0090489 A1
(43) Pub. Date: Mar. 21, 2024

(54) METHOD OF ACOUSTICALLY DETECTING EARLY TERMITE INFESTATION

(71) Applicant: Nick Gromicko, Frederick, CO (US)

(72) Inventor: Nick Gromicko, Frederick, CO (US)

(21) Appl. No.: 18/370,270

(22) Filed: Sep. 19, 2023

Related U.S. Application Data
(60) Provisional application No. 63/407,741, filed on Sep. 19, 2022.

(51) Int. Cl. A01M 1/02; A01M 1/24

(52) U.S. Cl. CPC A01M 1/026; A01M 1/24

(57) ABSTRACT

There is disclosed a method for early detection of termite activity within a suspect zone of a building that contains environmental noise maskable of the termite activity. An environmental knowledge base may be collected to represent identified termite activity plus background noises present in the suspect zone. A termite pattern library may represent a variety of termite sound patterns discoverable during a termite inspection without noise. A deep learning model may be trained on the sound patterns and the environmental knowledge for learning to discern the presence of termite activity and for producing an intelligent algorithm installable in the sampling device. A primary audio transducer may be configured to the sampling device and directed toward a sample location in the suspect zone to collect an audio sample. By operation of the intelligent algorithm, the device may indicate the presence of at least one sound pattern of the termite activity.

### CROSS REFERENCE TO RELATED APPLICATIONS

This patent application claims priority to U.S. Provisional Application No. 63/407,741 filed on Sep. 19, 2022 and entitled METHOD OF ACOUSTICALLY DETECTING EARLY TERMITE INFESTATION, the entire contents of Application 63/407,741 being expressly incorporated by reference herein.

### BACKGROUND

Termite inspectors may use visual cues and poking tools to identify termite activity and a degree of infestation. However, about 75 percent of the building structure may be visually inaccessible [IEEE Ultrasonic Symposium, 1991, pp. 1047-1051]. And, successful visual detection usually means that infestation is advanced, such as seeing multiple termite tunnels on the outside of framing members, or even hearing rustling or clicking sounds that may indicate a type of activity or an alarm message. Treatment may require that occupants vacate the building.

Technical tools may provide a deeper look into the structures for signs of early infestation, such as the thermal imaging of US20090046759 which scans for changes in interior wood condition (FIG. 1). Other tools, such as those disclosed in US20060226993, US20060028345, U.S. Pat. Nos. 5,285,688, and 4,809,554, may interrogate the structures by transmitting RF or acoustic waves into the building structures and observing the reflected energy in order to locate tunnels or termite movement (FIG. 2). However, thermal and interrogative techniques can be expensive, bulky, and/or invasive (e.g. the bolt in FIG. 2a). Additionally, interrogation techniques may detect only advanced infestation, and may be too insensitive to determine a low intensity of termite activity. Acoustic detection techniques may not sense all of several types of activity, such as a colony alarm signal, rustling tunnel movement, or rate of feeding (FIG. 3). Also, acoustic reflections from an interrogation may be too weak to compete with the noise levels in today's work-at-home household, compared to 20 years ago.

In non-analogous prior art, Krisp™ (FIG. 4) may employ a deep neural network to suppress environmental noise in a speaker's environment to send cleaned-up audio to listeners on Zoom® calls. However, the method does not identify termite sound patterns, nor translate and decode the spoken words, nor does it train on identified speakers before the Zoom® call.

More frequent and thorough inspections using a combination of the most sophisticated tools may increase a success rate for catching an early infestation. However, there's still a risk of forgetting to schedule an inspection, and the house or building may sometimes be empty for months, such as when the occupants leave for a winter home.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is disclosed a method of using a portable sampling device for early detection of termite activity within a suspect zone of a building made with wood. The suspect zone may contain environmental noise maskable of at least one sound pattern of the termite activity discoverable in the building. The method may further comprise collecting an environmental knowledge base representing a variety of environmental noises potentially present in the suspect zone. The method may further comprise establishing a termite pattern library representing a variety of termite sound patterns discoverable during a termite inspection of the suspect zone without the noise. At least a portion of the pattern library may be accessible by or storable within the sampling device. A deep learning model based on an artificial neural network may be provided for learning to discern the at least one sound pattern from the variety of sound patterns in the presence of the variety of environmental noises.

The method may further comprise training the deep learning model on the variety of sound patterns in the termite pattern library in order to produce an intelligent algorithm installable in the sampling device for detecting the termite activity. During the termite inspection, a primary audio transducer may be configured to the sampling device and directed toward a sample location in the suspect zone. An audio sample may be collected from the sample location and be substantially within the human frequency range of 20 Hz-20 kHz. The method may further include evaluating the audio sample, using the intelligent algorithm, for a match with at least one of the variety of sound patterns in the termite pattern library. The sampling device may be configured to indicate an intensity of the termite activity if the intensity is greater than an activity threshold.

In a further embodiment, there is disclosed a method of continuously monitoring a building made with wood for an early detection of termite activity within one or more suspect zones of the building. Each of the suspect zones may include environmental noise maskable of at least one sound pattern of the termite activity discoverable in the building. The method may comprise establishing a termite sound pattern library representing a variety of identified termite sound patterns discoverable during a termite inspection. A deep learning model based on an artificial neural network may be provided for learning to discern the at least one sound pattern from the variety of sound patterns and the environmental noises. The method may further comprise collecting environmental training data consisting of many samples of identified termite activity in representative buildings including the environmental noises of their respective suspect zones.

The method may further comprise training the deep learning model on the environmental training data and the identified sound patterns in the pattern library for producing an intelligent algorithm capable of detecting the termite activity. The intelligent algorithm may be independent of the deep learning model. A weather-resistant stationary monitoring unit operable of the intelligent algorithm may be positioned at a sample location within each of the one or more suspect zones. Each of the monitoring units may include an alert output and a primary audio transducer configured to listen to the corresponding suspect zone.

The method may further include periodically collecting a zone sample from one or more of the sample locations and substantially within the human frequency range of 20 Hz-20 kHz. Each of the collected zone samples may be then evaluated, using the intelligent algorithm, for a match with at least one of the variety of sound patterns in the termite pattern library. The alert output may be activated when an intensity of the termite activity exceeds an activity threshold of one or more of the monitoring units.

In another embodiment, there is disclosed a system for detecting early termite activity within a suspect zone of a building made with wood. The suspect zone may include environmental noise maskable of at least one sound pattern of the termite activity discoverable in the building. The system may comprise a sampling device having a primary audio transducer configured to collect a zone sample of the termite activity within the suspect zone. The system may further comprise a termite sound pattern library representing a variety of identified termite sound patterns discoverable during a termite inspection of the suspect zone without the noise. The system may further comprise an environmental training database including many samples of identified termite activity in representative buildings including the environmental noises in their respective suspect zones.

The system may further comprise a deep learning model based on an artificial neural network and communicable with the sampling device, the pattern library, and the training database. The learning model may be configured to train on the variety of sound patterns and the environmental noises. The training of the deep learning model may produce an intelligent algorithm operable on the sampling device for evaluating the zone sample collected in the suspect zone. The intelligent algorithm may detect the presence of one or more of the variety of sound patterns in the termite pattern library.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates a prior art pictorial of thermal imaging for detecting a termite infestation.

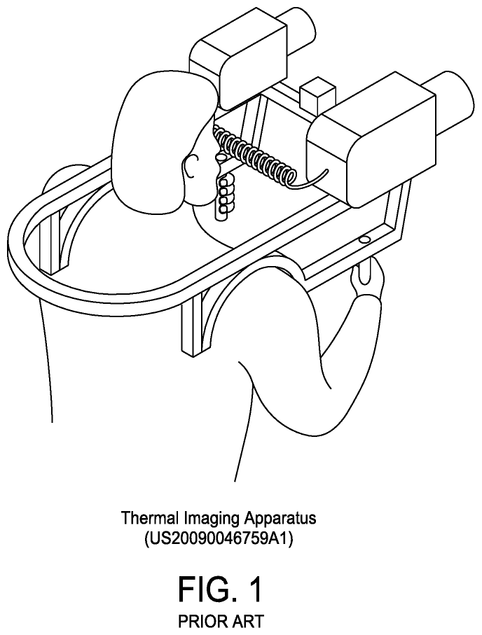

FIGS. 2a-2c illustrate a prior art acoustic stimulation and responses for detecting a termite infestation.

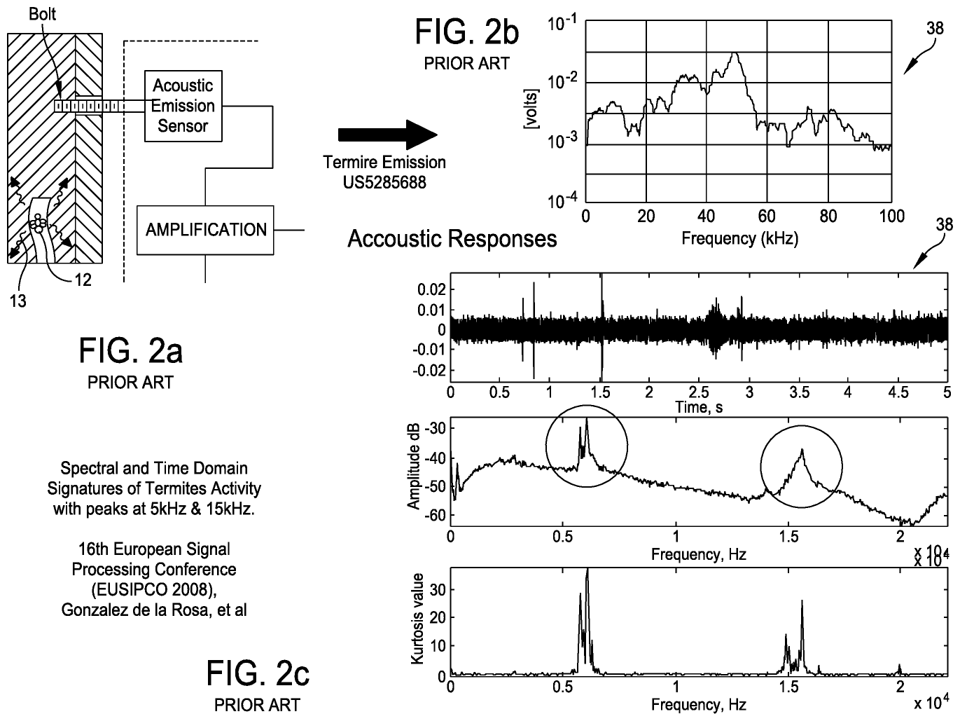

FIG. 3 lists prior art descriptions of termite sound patterns.

FIG. 4 illustrates a non-analogous prior art methodology for suppressing background sounds in a human audio transmission.

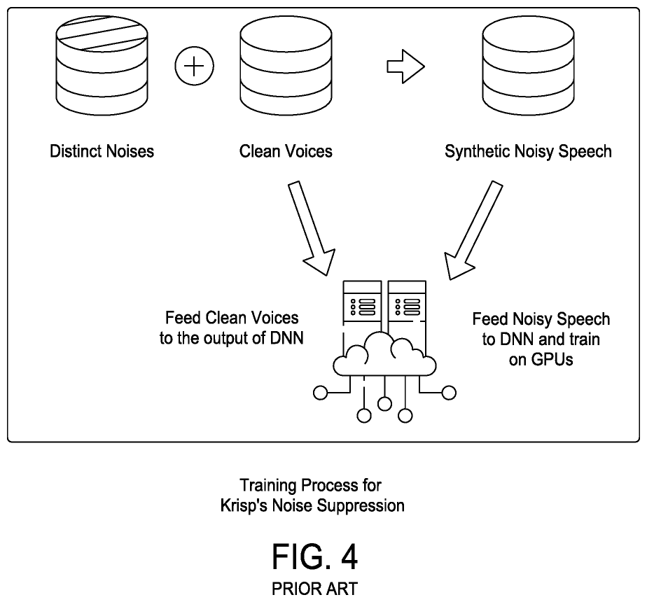

FIG. 5 illustrates an early termite detection system applied to a suspect zone, in accordance with an embodiment of the present disclosure.

FIG. 6 illustrates a detection process for the early termite detection using a deep learning model, in accordance with an embodiment of the present disclosure.

FIG. 7 illustrates training data collection for the early termite detection system, in accordance with an embodiment of the present disclosure.

FIGS. 8a-8b illustrate a perspective view of a training data collector for the early termite detection system, in accordance with an embodiment of the present disclosure.

FIG. 9 illustrates a perspective view of a GPU-CPU module of the training data collector, in accordance with an embodiment of the present disclosure.

FIG. 10 illustrates a schematic of a carrier board for the GPU-CPU module of the early termite detection system, in accordance with an embodiment of the present disclosure.

FIG. 11 illustrates a top architectural view of a network of stationary monitoring units of the early termite detection system, in accordance with an embodiment of the present disclosure.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

As may be appreciated, based on the disclosure, there exists a need in the art for a sensitive and non-invasive method of termite inspection that can discern a type and an intensity of termite activity that is subaudible, thereby discerning an early infestation. Also, there exists a need in the art for a portable device that acoustically detects a variety of signatures of the termite activity which conduct through wooden structures that otherwise appear undamaged. Additionally, there exists a need in the art for the acoustic detector to filter out environmental noises present in an inspection area, especially given the prevalence of beeping electronic devices and more work-at-home inhabitants. Further, there exists a need in the art for a small stationary monitor to automatically and periodically listen for early termite infestation in several key locations around the house.

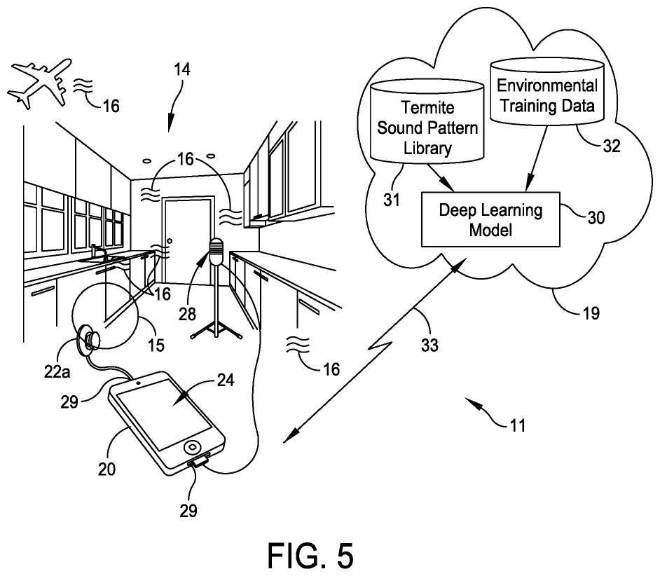

Referring now to FIGS. 5-7, in various embodiments, there is described a method of using a portable sampling device 20 for early detection of termite activity within a suspect zone 14 of a building 21 (not shown) made with wood. The portable device 20 may be configurable for use by a termite expert 17 collecting real-time zone samples intermittently from multiple of the suspect zones 14 in sequence. In FIG. 5, the suspect zone 14 is a kitchen. The suspect zone 14 may contain environmental noise maskable of at least one sound pattern of the termite activity discoverable in the building 21. The method may further include establishing a termite sound pattern library 31 representing a variety of termite sound patterns discoverable during a termite inspection of the suspect zone 14 without the noise. At least a portion of the pattern library may be accessible by or storable within the sampling device 20, shown in FIG. 5 as a smart phone, so that test results may be checked against pure sound patterns.

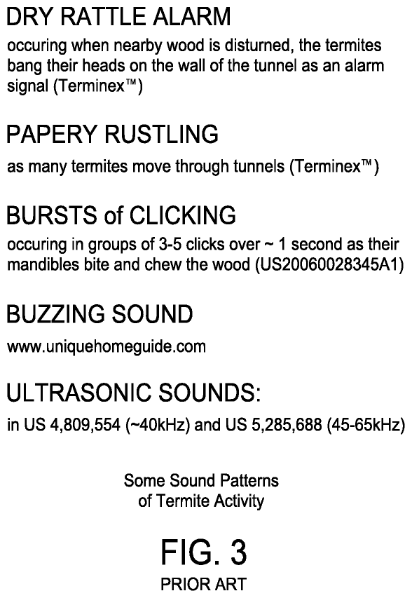

The variety of sound patterns storable in the pattern library 31 may comprise different types of termite activity indicative of a degree of infestation, and which may be useful in discerning an early infestation from an advanced infestation. The sound patterns (FIG. 3) of a termite colony may include a dry rattle, a papery rustling sound, clicking sounds (also pop, crackle), a buzzing sound, and ultrasonic sounds. The sound patterns may also be signatures of combinations of types of termite activity and intensity.

Continuing with FIGS. 5-7, in various embodiments, the method may include providing a deep learning model 30 based on an artificial neural network for learning to discern the at least one sound pattern from the variety of sound patterns and in the presence of the variety of the environmental noises. Recent advances in speech-to-text technology and facial recognition, through machine learning, may be applied to recognizing termite ‘words’ (sound patterns) and/or filtering out the background noise that masks the sound patterns. In addition to the development of these neural networks, increases in processor speed and memory size may enable smart phones to provide this ‘voice recognition’ capability.

The deep learning model 30 may include one or more of a convolutional neural network (CNN), a recurrent neural network algorithms, a connectionist temporal classification (CTC), attention mechanisms, an autoencoder, a variable autoencoder, transfer learning, and a traditional machine learning technique including one or more of a support vector machine, random forests, and a k-nearest-neighbor model.

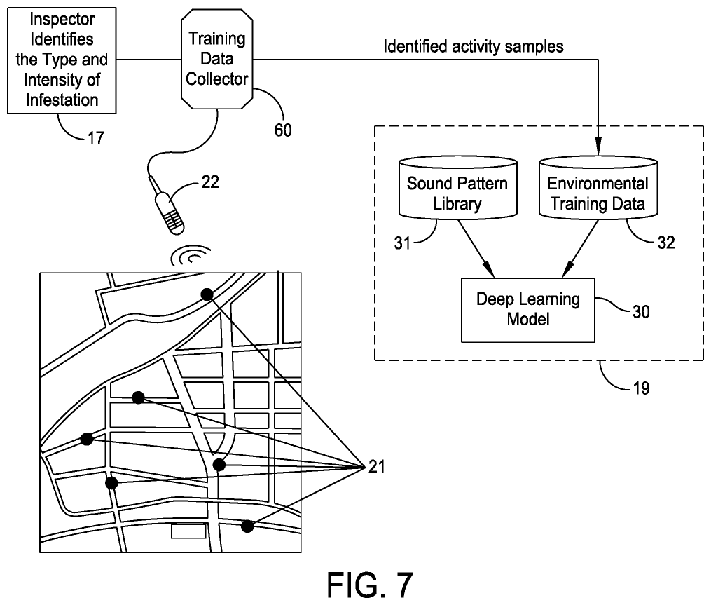

Referring still to FIGS. 5-7, the method may include collecting (FIG. 7) and storing environmental training data 32 consisting of many samples of identified termite activity taken in representative buildings 21, the samples including the environmental noises of the respective suspect zones 14. The variety of environmental noises interfering with termite detection may include one or more of the following human-made and natural noises inside or outside of the building: a dog barking, a door shutting, air blowing from a HVAC system, an airplane flying overhead, street noise, talking near the suspect zone, a baby crying, a police siren, a faucet running, an appliance humming, and music from the room next door. The environmental training data 32, the termite sound pattern library 31, and the deep learning model 30 may be located in a centralized computing center or distributed data locations accessible through the cloud 19, as shown in FIGS. 5-7, and may be connectible to the portable device 20 through a wireless internet link 33.

Continuing with FIGS. 5-7, in various embodiments, the method may further include training the deep learning model 30 on the environmental training data 32 and the identified sound patterns in the pattern library 31 for producing an intelligent algorithm 25 for detecting the termite activity independently of the deep learning model 30. Once pre-trained on centralized servers, the model 30 may be reduced to a small computational footprint in the form of the intelligent algorithm 25 for installation on the portable sampling device 20.

The combination of various stationary and non-stationary termite signatures may trend, cycle, or randomly walk. This non-stationarity suggests that substantial training of the deep learning model may be required, using a large number of training data samples. At least hundreds or thousands of training samples, classified (identified) into particular termite activities by human experts, may be fed to the model 30 for developing the algorithm 25. The complexity and meandering of a colony's sound pattern may be akin to a human conversation having distinct and repeated ‘words’ as well as complex ‘phrases’, and a swelling and receding of intensity and spectral tonality that characterize emotional human speech.

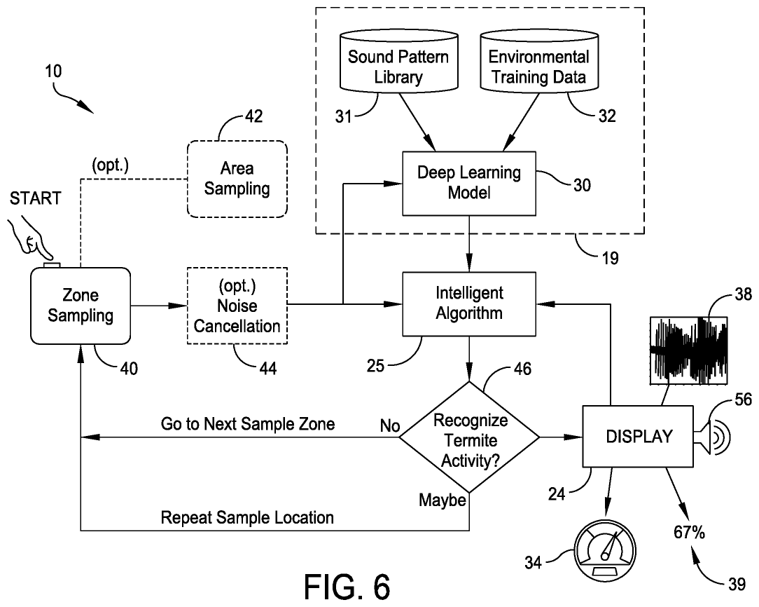

Training data and termite sound patterns may need to include samples across local geography, climate, time of year, temperature, humidity, varieties of wood, and age of a colony. The model 30 may also make use of graphical processing units (GPU) and spectrograms 38 (FIG. 6), which are frequency-time-amplitude signatures of an audio sample.

Referring again to FIGS. 5-7, in various embodiments, the method may further include directing, during the termite inspection, a primary audio transducer 22/22a configured to the sampling device 20 and toward a sample location 15 in the suspect zone 14. The method may further include collecting 40 (FIG. 6) a zone sample from the sample location 15 and substantially within the human frequency range of 20 Hz to 20 kHz. For instance, the suspect zone 14 may be the kitchen in FIG. 5 and the sample location 15 may be a baseboard near the sink cabinet.

The primary transducer 22 may be a microphone (not shown) built into the portable sampling device 20 or a smart phone. The primary transducer 22 may also be a contact transducer 22a (e.g. stethoscope or piezoelectric transducer) placeable against a solid surface in the suspect zone 14 for improving a signal-to-noise (SNR) ratio between the termite activity and the environmental noise. In a preferred embodiment, the primary transducer 22 may be a directional microphone for maximizing the receipt of the termite sound pattern.

Alternatively, the sampling device 20 and primary audio transducer 22 may be configured to sample substantially in the ultrasonic range above 20 kHz, and which may extend up to 100 kHz. A length of the zone sample may be a matter of seconds, or may be a matter of minutes. The zone samples may also be accumulated by the sampling device 20 and uploaded to the termite pattern library 31 and environmental database 32 for further ‘lab learning’ and training of the deep learning model 30. The uploading may take place over the wireless link 33.

Continuing with FIGS. 5-7, in a preferred embodiment, the method may further include evaluating 46 (FIG. 6) the zone sample, using the intelligent algorithm 25, for a match with at least one of the variety of sound patterns in the termite pattern library 31, and indicating, by the sampling device 20, an intensity 34 of the termite activity if the intensity 34 is greater than an activity threshold. Alternatively, the method may include indicating, by the sampling device 20, the presence of one or more of the variety of sound patterns in the termite pattern library when there is a match with at least one of the variety of sound patterns in the library 31. If there is a match (“Yes” in FIG. 6), the sampling device 20 may display 24 an intensity 34 of the termite activity. For example, the intensity 34 may be a probabilistic indication of some level of termite activity above the threshold and existing at the sample location 15. Alternately, the intensity 34 may be a decibel level. In one embodiment, the display 24 on the sampling device 20 may be configured to indicate the detection of one or more sound patterns in terms of one or more of an intensity 24, a type of activity, and a probability of infestation.

The indicating 24 may also include one or more of the following status outputs: a time-waveform image (not shown) of the sound pattern, a spectral image 38 of the sound pattern, a confidence indicator 39, and a recording 36 of the termite activity for playback to an operator of the sampling device 20. For example, a sound of the collected zone sample played back may help the operator assess one or more of a degree of infestation and a type of the at least one sound pattern. Indications of the type and the intensity 34 may be displayed on a screen 24 of the sampling device 30, and together may suggest the degree of infestation. The indicated type may describe a termite species and/or a type of activity (e.g. dry rattle alarm).

If there is an ambiguous result 46 (“Maybe”), the sampling device 20 may recommend moving to another sampling location 15 in the same suspect zone 14, repeating the zone sample, varying the microphone distance at the same sample location 15 in order to get a different SNR, reducing the environmental noise at a source in the suspect zone 14, or collecting a purely environmental noise sample. For example, referring to FIG. 5, reducing the environmental noise may include turning off the water, turning off an appliance, waiting until a plane is done flying overhead, or turning off the dishwasher. If there is a negative result (“No”), an operator of the sample device 20 may mark the current suspect zone as “clean” and opt to move onto the next suspect zone 14.

The link 33 between the portable sampling device 20 and the centralized deep learning model 30 may be maintained in order to update the intelligent algorithm 25, upload zone samples, upload test results, download termite sound patterns (signatures), and/or further train the deep learning model 30 with new zone samples. The portable sampling device 20 may operate independently of the deep learning model and may run the intelligent algorithm on an application in order to provide real-time results. Alternatively, the portable device may include a wireless link to the model 30, training data 32, and termite library 31 in order to support an interactive mode of sample evaluation.

Continuing with FIGS. 5-6, in various embodiments, the method may include collecting an area sample of primarily the environmental noise within the suspect zone 14, during the zone sampling via the primary transducer 22, by directing an area audio transducer 28 to the sampling device 20, the area sample for improving a signal-to-noise ratio of the zone sample. The area transducer 28 may be mounted on a tripod, as in FIG. 5. The intelligent algorithm 25 may then utilize this secondary and concurrent input 28 to improve its evaluation of the zone sample and more accurately identify the type and the intensity 34 of the termite activity in the suspect zone 14. For example, the sampling device 20 may include a noise cancelling processor (not shown) for subtracting the site-specific environmental noise from the zone sample and thereby improve the SNR of the zone sample prior to or during operation of the intelligent algorithm 25. The sampling device 20 may cancel a portion of the environmental noise from the zone sample by applying one or more of the following techniques: spectral filtering, a feed-forward techniques to account for phase differences in noise arriving from the two different microphones, and a neural network.

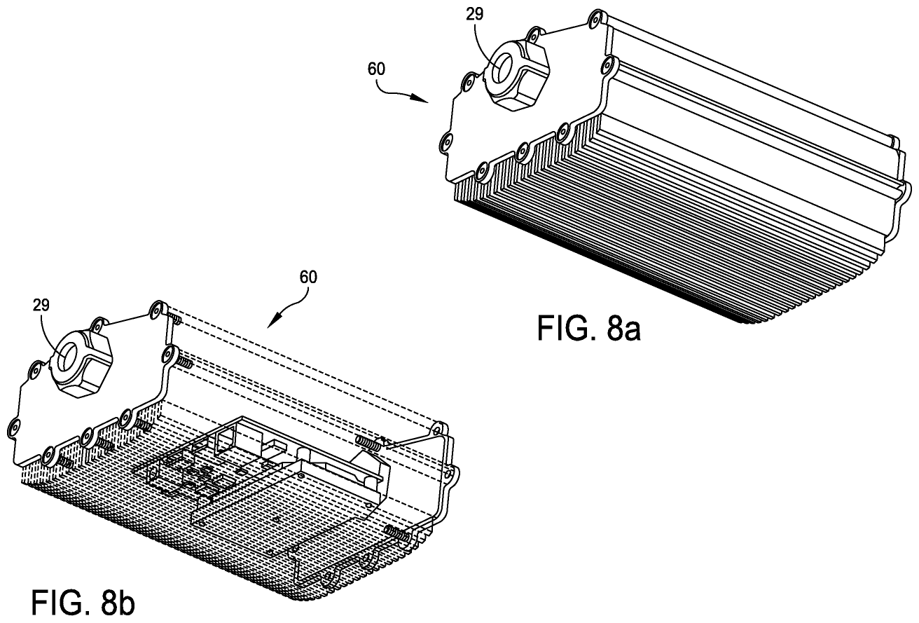

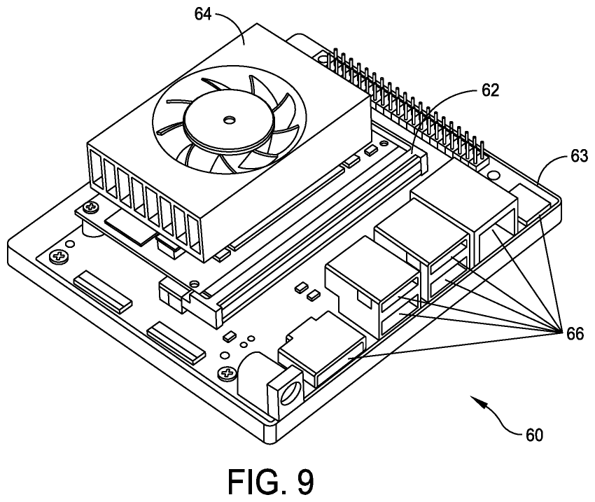

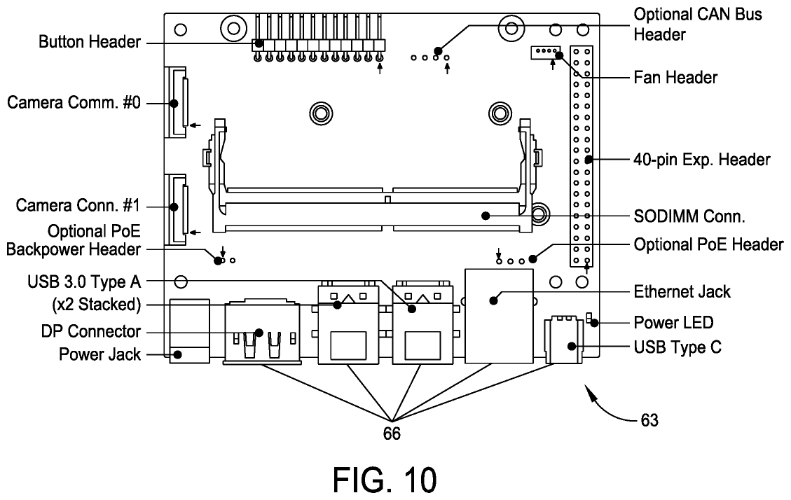

Referring now to FIGS. 7-10, in various embodiments, the early detection system 11 may include a training data collection system 18 (FIG. 7) for establishing the environmental training database 32. The training data collection system 18 may include a training data collector (a device) 60 operable by a termite expertise 17 and configured to collect the many samples of identified termite activity from the representative buildings 21 in the appropriate cities and geographies. The data collector 60 may also accrue/store the environmental training data and may upload the identified activity samples to the environmental training database 32 for training the deep learning model 30.

Continuing with FIGS. 7-10, in various embodiments, the data collector 60 may comprise a portable and specialized GPU-CPU processor 62 mounted to a carrier board 63 and may include an input 29 for at least one of a microphone 22 and a contact transducer 15. A variety of data and video connectors 66 may be disposed on carrier board 63 for supporting two or more audio transducer inputs. Microphones 22 (not shown here) and transducer 15 may be mounted on carrier board 63, remoted via Bluetooth™, and/or cabled via one of the data connectors 66. A cooling fan 64 may mount on top of the processor 62 for cooling the GPU-CPU processor 62. In an alternative embodiment, the data collector 60 may comprise a smart phone configured with one or more of an internal microphone and the microphone input 29 (not shown).

The GPU (graphics processing unit)-CPU controlled instrument 60 may enable a kind of edge computing, integrating data collection and analysis close to the source. In one embodiment, the unit 60 may also be configured to operate the intelligent algorithm 25 and function thereby as the portable sampling device 20, collecting zone samples during the termite inspection 10. Advantageously, the specialized training data collector 60 may be able to devote all of its processing power to training data collection, and potentially to the portable sampling, as compared to a smart phone which may need to reserve much of its processing power and memory for cellular communication and multiple other applications. This additional computing power of the GPU-CPU 62 may eliminate the need to move large (spectral) image files to the cloud 19 when the complexity of running the intelligent algorithm 25 exceeds that handleable by a smart phone.

Continuing with FIG. 7, the expertise 17 may listen to audio playback and evaluate spectral and time-domain aspects of the activity samples through one or more of the data connectors 66 in order to confirm the identity of the termite sound pattern and the type and intensity of that activity. Additionally, human expertise 17 may perform thorough visual and mechanical inspections of the suspect zone 14 in order to confirm the type and the intensity of the activity. The environmental samples which have been identified as containing one or more termite sound patterns, and are therefore useful, may be uploaded from the training data collector 60 to the training database 32 via cabled or wireless means 33 (FIG. 5), either on-site or at a later time.

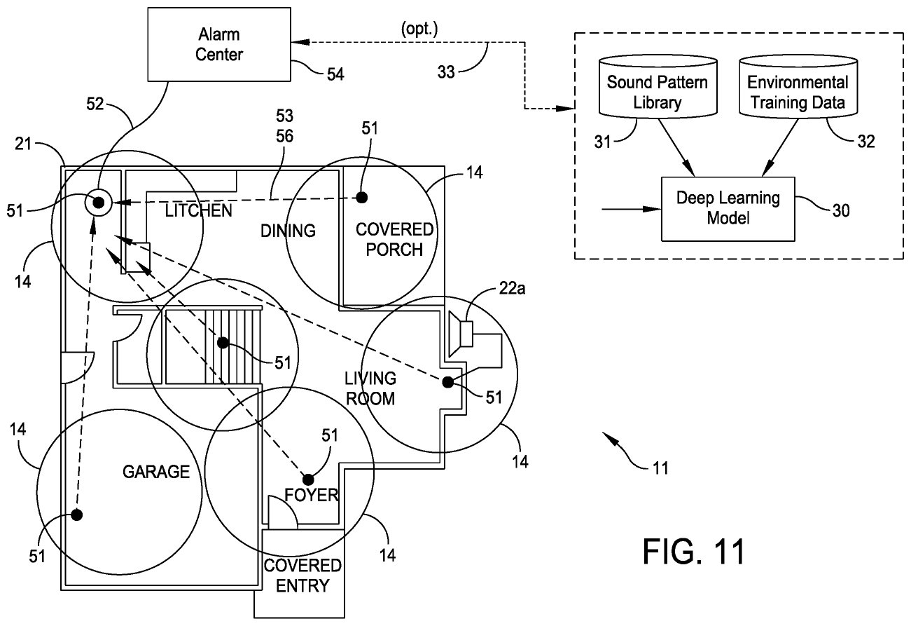

Referring now to FIGS. 5 and 11, in an embodiment, the sampling device 20 may be configured as a weather-resistant stationary monitoring unit 51 unit positionable (or hidable) in multiplicity at each of one of the multiple suspect zones 14 in the building 21 for continuously detecting early termite activity. A stationary monitoring system 11 may comprise the multiplicity of the monitoring units 51 each configured with a primary audio transducer 22/22a for periodically collecting and storing a zone sample from the corresponding suspect zone 14. Each unit 51 may include an alert output 56 activated when an intensity of the termite activity exceeds the activity threshold. System stationary monitoring system 11 may include monitor network links 53 between each of the multiple units 51, and one of the units 51 may be designated to terminate the network links 53 from the other units 51 and communicate to an alarm center 54 via cable, Bluetooth, or a proprietary RF network. In a more generic embodiment, the alert outputs 56 of two or more of the stationary monitoring units 51 proximate the building 21 may be networked to an alarm center 54 for providing a coordinated indication of when the activity threshold has been exceeded.

Additionally, in an embodiment not shown, the stationary monitoring system 11 may include one or more battery-powered test transmitters configured to emit a simulated termite sound pattern. The test transmitter may be mountable to, or placeable near, wooden members of the building 21. The termite transmitters may be scheduled to periodically and acoustically radiate one or more sound patterns simulating early termite infestation in order to verify that the network of stationary monitoring units 51 are operating correctly by producing an alert output 56. The test pattern could be broadcast, for example. at 10 am every Monday morning so that each monitoring unit 51 knows to send out a “confirm test” signal to the alarm center instead of “termites detected” signal.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A method of using a portable sampling device for early detection of termite activity within a suspect zone of a building made with wood, where the suspect zone includes environmental noise maskable of at least one sound pattern of the termite activity discoverable in the building, the method comprising:
establishing a termite sound pattern library representing a variety of identified termite sound patterns discoverable during a termite inspection of the suspect zone without the environmental noise;
providing a deep learning model based on an artificial neural network for learning to discern the at least one sound pattern from the variety of sound patterns and the environmental noises;
collecting environmental training data consisting of many samples of identified termite activity in representative buildings including the environmental noises of their respective suspect zones;
training the deep learning model on the environmental training data and the identified sound patterns in the pattern library for producing an intelligent algorithm for detecting the termite activity independent of the deep learning model;
directing, during the termite inspection, a primary audio transducer configured to the sampling device and toward a sample location in the suspect zone;
collecting a zone sample from the sample location and substantially within the human frequency range of 20 Hz-20 kHz;
evaluating the zone sample, using the intelligent algorithm, for a match with at least one of the variety of sound patterns in the termite pattern library; and
indicating, by the sampling device, an intensity of the termite activity if the intensity is greater than an activity threshold.

2. The early termite detection method of claim 1, further comprising:
indicating a type of the at least one matched sound pattern when the activity threshold is exceeded, the type and the intensity suggesting a degree of infestation, and where the type is one or more of a termite species and a type of activity.

3. The early termite detection method of claim 1, wherein:
the variety of environmental noises include one or more of the following human-made and natural noises potentially inside or outside of the building: a dog barking, a door shutting, air blowing from a HVAC system, an airplane flying overhead, street noise, talking near the suspect zone, a baby crying, a police siren, a faucet running, an appliance humming, and music from the room next door.

4. The early termite detection method of claim 1, wherein:
the deep learning model includes one or more of a convolutional neural network (CNN), attention mechanisms, an autoencoder, a variable autoencoder, transfer learning, and a traditional machine learning technique including one or more of a support vector machine, random forests, and a k-nearest-neighbor model.

5. The early termite detection method of claim 1, further comprising:
collecting an area sample of the environmental noise within the suspect zone during the zone sampling by directing an area audio transducer to the sampling device, the area sample for improving a signal-to-noise ratio of the zone sample.

6. The early termite detection method of claim 5, further comprising:
cancelling a portion of the environmental noise from the zone sample by applying the corresponding area sample to one or more of the following techniques: spectral filtering, a feed-forward technique, and a neural network.

7. The early termite detection method of claim 1, wherein:
the primary transducer is one of the following:
a microphone in open air, and
a contact transducer placeable against a solid surface in the suspect zone for improving a signal-to-noise ratio between the termite activity and the environmental noise.

8. The early termite detection method of claim 1, wherein:
the portable sampling device is one of a smart phone and a training data collector, each configurable with an application for running the intelligent algorithm downloadable from the deep learning model, the training data collector comprising a portable and specialized GPU-CPU unit for collecting the environmental training data.

9. The early termite detection method of claim 1, further comprising:
including one or more of the following status outputs in the indicating step: a time-waveform image of the sound pattern, a spectral image of the sound pattern, a confidence indicator, and a recording of the termite activity for playback.

10. The early termite detection method of claim 1, further comprising:
playing back, for an operator of the sampling device, a sound of the collected zone sample for assessing one or more of a degree of infestation and a type of the at least one sound pattern.

11. A method of continuously monitoring a building made with wood for an early
detection of termite activity within one or more suspect zones of the building, where each of the suspect zones includes environmental noise maskable of at least one sound pattern of the termite activity discoverable in the building, the method comprising:
establishing a termite sound pattern library representing a variety of identified termite sound patterns discoverable during a termite inspection;
providing a deep learning model based on an artificial neural network for learning to discern the at least one sound pattern from the variety of sound patterns and the environmental noises;
collecting environmental training data consisting of many samples of identified termite activity in representative buildings including the environmental noises of their respective suspect zones;
training the deep learning model on the environmental training data and the identified sound patterns in the pattern library for producing an intelligent algorithm for detecting the termite activity independent of the deep learning model;
positioning a weather-resistant stationary monitoring unit operable of the intelligent algorithm at a sample location within each of the one or more suspect zones, each of the monitoring units having an alert output and a primary audio transducer configured to listen to the corresponding suspect zone;
periodically collecting a zone sample from one or more of the sample locations and substantially within the human frequency range of 20 Hz-20 kHz;
evaluating each of the collected zone samples, using the intelligent algorithm, for a match with at least one of the variety of sound patterns in the termite pattern library; and
activating the alert output when an intensity of the termite activity exceeds an activity threshold of one or more of the monitoring units.

12. The early termite detection method of claim 11, further comprising:
indicating in the alert output, when the activity threshold is exceeded, a type of termite activity corresponding to the at least one matched sound pattern.

13. The early termite detection method of claim 11, further comprising:
networking the alert outputs of two or more of the stationary monitoring units in the building to an alert center for providing a coordinated indication of when the activity threshold has been exceeded.

14. The early termite detection method of claim 11, wherein:
the primary audio transducer is one of the following:
a microphone in open air, and
a contact transducer placeable against a solid surface in the suspect zone for improving a signal-to-noise ratio between the termite activity and the environmental noise.

15. The early termite detection method of claim 11, wherein:
the deep learning model includes one or more of a convolutional neural network (CNN), attention mechanisms, an autoencoder, a variable autoencoder, transfer learning, and a traditional machine learning technique including one or more of a support vector machine, random forests, and a k-nearest-neighbor model.

16. A system for detecting early termite activity within a suspect zone of a building made with wood, where the suspect zone includes environmental noise maskable of at least one sound pattern of the termite activity discoverable in the building, the system comprising:
a sampling device having a primary audio transducer configured to collect a zone sample of the termite activity within the suspect zone;
a termite sound pattern library representing a variety of identified termite sound patterns discoverable during a termite inspection of the suspect zone;
an environmental training database including many samples of identified termite activity in representative buildings including the environmental noises in their respective suspect zones; and
a deep learning model based on an artificial neural network and communicable with the sampling device, the pattern library, and the training database, the learning model for training on the variety of sound patterns and the environmental noises; and
where training the deep learning model produces an intelligent algorithm operable on the sampling device for evaluating the zone sample collected in the suspect zone, the intelligent algorithm for detecting the presence of one or more of the variety of sound patterns in the termite pattern library.

17. The early detection system of claim 16, further comprising:
a display on the sampling device for indicating the termite activity corresponding to the detected one or more sound patterns in terms of one or more of an intensity, a type of activity, and a probability of infestation.

18. The early detection system of claim 16, wherein:
the deep learning model includes one or more of a convolutional neural network (CNN), attention mechanisms, an autoencoder, a variable autoencoder, transfer learning, and a traditional machine learning technique including one or more of a support vector machine, random forests, and a k-nearest-neighbor model.

19. The early detection system of claim 16, further comprising:
a training data collector comprising a portable and specialized GPU-CPU unit and at least one of a microphone and a contact transducer, the training data collector being configured for collecting the samples of identified termite activity from the representative buildings, accruing the environmental training data, and uploading the identified samples to the environmental training database for training the deep learning model.

20. The early detection system of claim 16, wherein:
the sampling device is one of a portable sampling device and a weather-resistant stationary monitoring unit, the portable device configured for a termite inspector collecting real-time zone samples intermittently from multiple of the suspect zones in sequence, and the stationary monitoring unit positionable in multiplicity at each of one of the multiple suspect zones in the building, each of the multiple monitoring units having an alert output and configured to periodically collect a zone sample.
